(19) United States
(12) Patent Application Publication
(10) Pub. No.: US 2023/0066261 A1
(43) Pub. Date: Mar. 2, 2023

(54) Dual Polarized Antenna Feed System

(71) Applicant: PCTEL, Inc., Bloomingdale, IL (US)

(72) Inventor: Robert Gunnels, Homer Glen, IL (US)

(73) Assignee: PCTEL, INC.

(21) Appl. No.: 17/458,979

(22) Filed: Aug. 27, 2021

(51) Int. Cl. H01Q 19/195; H01Q 15/24; H01Q 15/22

(52) U.S. Cl. CPC H01Q 19/195; H01Q 15/246; H01Q 15/22

(57) ABSTRACT

A dual polarized antenna feed system can include a first single polarized antenna feed element oriented on a first axis relative to a polarization filter and a second single polarized antenna feed element oriented on a second axis relative to the polarization filter such that the first and second axes are not common and not parallel. The polarization filter can include a plurality of conductors, a polarization of the first single polarized antenna feed element can be parallel to the plurality of conductors so that the polarization filter can reflect a majority of incident signals originating from the first single polarized antenna feed element, and a polarization of the second single polarized antenna feed element can be orthogonal to the plurality of conductors so that the polarization filter can be transparent to a majority of incident signals originating from the second single polarized antenna feed element.

### FIELD

The present invention generally relates to radio frequency (RF) communications hardware. More particularly, the present invention relates to antennas and antenna feed systems.

### BACKGROUND

Antennas, such as broadband parabolic reflectors, can be illuminated by a feed system, such as a log periodic dipole array (“LPDA”). For dual polarized applications, dual polarized LPDAs can be assembled with a common axis for lower frequencies. However, such an assembly becomes difficult as the frequency increases. For example, with known techniques used to construct dual polarized LPDAs, one or more performance characteristics are compromised, including, for example, cross-polarization and port-to-port isolation performance, particularly at higher frequencies.

Broadband parabolic reflectors can also be illuminated by dual polarized Vivaldi type feeds. However, these systems produce a return loss that is typically not adequate for some applications.

In view of the above, there is a continuing, ongoing need for improved antenna feed systems.

### BRIEF DESCRIPTION OF THE DRAWINGS

FIG. 1 is a perspective view of a dual polarized antenna feed system according to disclosed embodiments;

FIG. 2 is a side view of a dual polarized antenna feed system according to disclosed embodiments;

FIG. 3 is a side view of a dual polarized antenna feed system according to disclosed embodiments;

FIG. 4 is a perspective view of a dual polarized antenna feed system according to disclosed embodiments; and

FIG. 5 is a graph of exemplary isolation between two antenna feed elements in a dual polarized antenna feed system according to disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

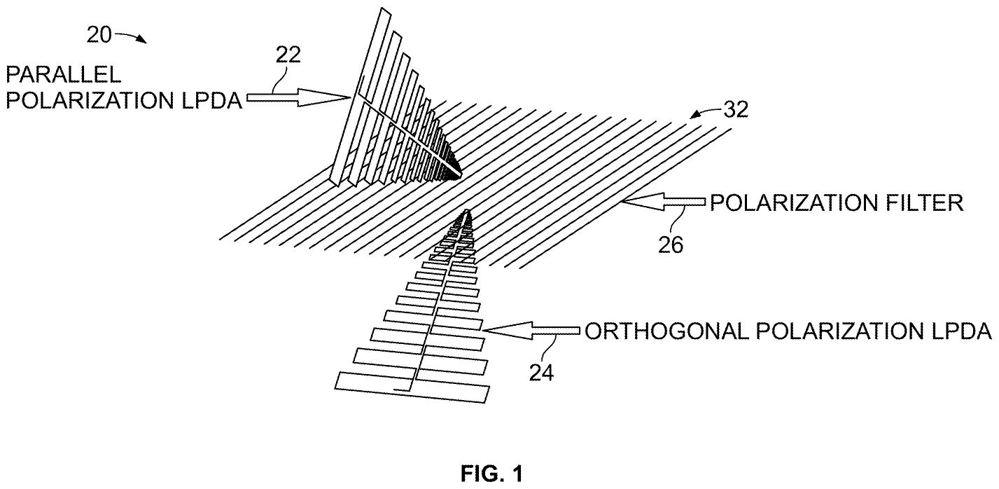

Embodiments disclosed herein can include a dual polarized antenna feed system and methods for operating and manufacturing such a system. FIGS. 1-3 illustrate a dual polarized antenna feed system 20 according to disclosed embodiments. As seen in FIG. 1, the dual polarized antenna feed system 20 can include a first single polarized antenna feed element 22, a second single polarized antenna feed element 24, and a polarization filter 26 positioned between the first single polarized antenna feed element 22 and the second single polarized antenna feed element 24. In some embodiments, the first single polarized antenna feed element 22 can be oriented on a first axis relative to the polarization filter 26, and the second single polarized antenna feed element 24 can be oriented on a second axis relative to the polarization filter 26 such that the first axis and the second axis are not common and not parallel. To maintain such orientations of the first single polarized antenna feed element 22, the second single polarized antenna feed element 24, and the polarization filter 26 relative to one another, in some embodiments, the first single polarized antenna feed element 22, the second single polarized antenna feed element 24, and the polarization filter 26 can be coupled to an open frame, a closed frame, and/or a housing support structure.

As best seen in FIG. 1, in some embodiments, the polarization filter 26 can include a plurality of conductors 32. In some embodiments, the plurality of conductors 32 can include, for example, a plurality of parallel metal wires, a plurality of parallel copper strips on a printed circuit board, and the like. As seen in FIGS. 1-3, in any embodiment, a polarization of the first single polarized antenna feed element 22 can be parallel to the plurality of conductors 32, and a polarization of the second single polarized antenna feed element 24 can be orthogonal to the plurality of conductors 32.

In some embodiments, the first single polarized antenna feed element 22 can include a LPDA, and the second single polarized antenna feed element 23 can include a LPDA. However, various other embodiments are also contemplated. For example, the first single polarized antenna feed element 22 and/or the second single polarized antenna feed element 24 can include a patch antenna, a waveguide horn, elements on a printed circuit board, and other antenna structures known in the art. Furthermore, in some embodiments, the dual polarized antenna feed system 20 can include mixed types of antenna structures where the first single polarized antenna feed element 22 has a different structure from the second single polarized antenna feed element 24.

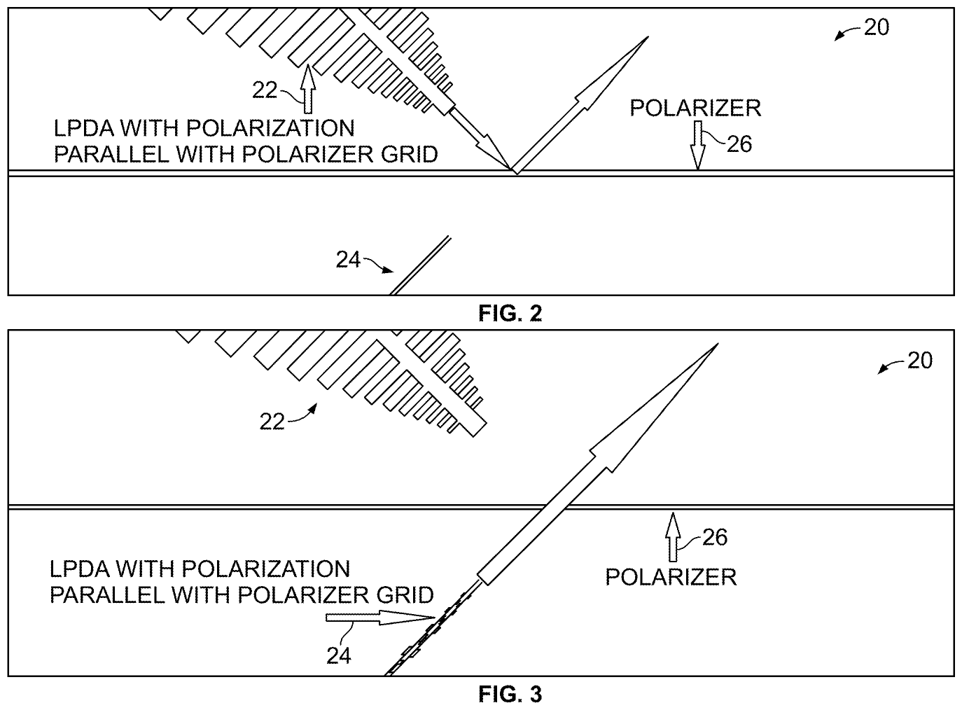

In operation, the polarization filter 26 can act as a reflector to incident signals originating from the first single polarized antenna feed element 22 and can be transparent to incident signals originating from the second single polarized antenna feed element 23. In particular, as seen in FIG. 2, the polarization filter 26 can reflect a majority of the incident signals originating from the first single polarized antenna feed element 22, and as seen in FIG. 3, a majority of the incident signals originating from the second single polarized antenna feed element 24 can pass through the polarization filter 26.

In some embodiments, relative angles and orientations of the first single polarized antenna feed element 22, the second single polarized antenna feed element 24, and the polarization filter 26 can be controlled to direct signal paths. For example, in some embodiments, the first axis on which the first single polarized antenna feed element 22 is oriented can be approximately 90° relative to the second axis on which the second single polarized antenna feed element 24 is oriented. Furthermore, the first axis can be approximately 45° relative to the polarization filter 26, and the second axis can be approximately 45° relative to polarization filter 26. In these embodiments, the incident signals originating from the first single polarized antenna feed element 22 can be directed towards the polarization filter 26 at a first angle relative to the polarization filter 26 and be reflected off of the polarization filter 26 at a second angle relative to the polarization filter such that the second angle can be perpendicular to the first angle and such that a redirected path of reflected signals can be parallel to a path of the incident signals originating from the second single polarized antenna feed element 24 and passing through the polarization filter 36.

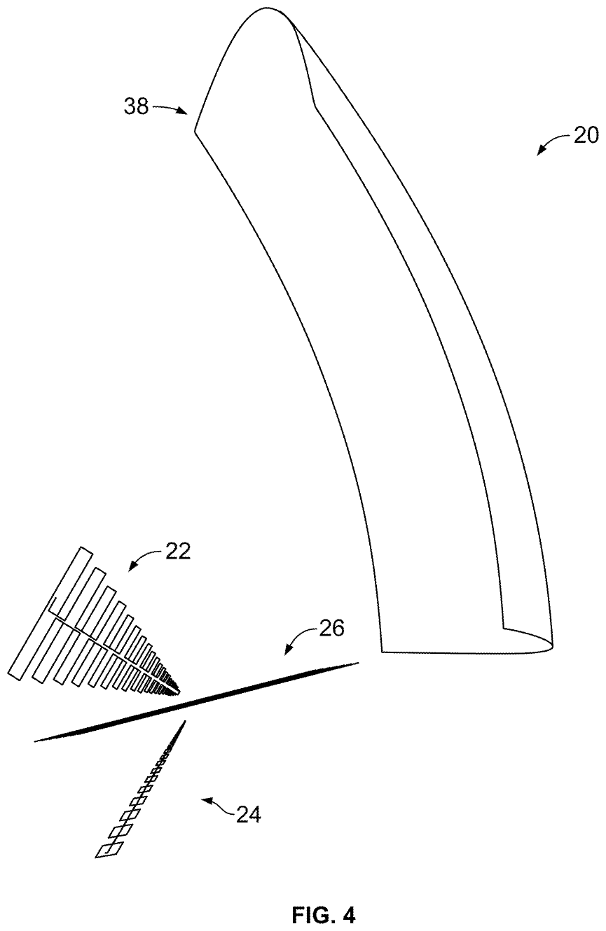

In some embodiments, such as the one illustrated in FIG. 4, the dual polarized antenna feed system 20 can feed a parabolic reflector 38. For example, the parabolic reflector can be positioned relative to the dual polarized antenna feed system so as to be fed by the incident signals originating from the first single polarized antenna feed system 22 and reflected by the polarization filter 26 and the incident signals originating from the second single polarized antenna feed system 24 and passing through the polarization filter 26.

Embodiments described herein can also include a method for constructing the dual polarized antenna feed system 20. For example, in some embodiments, the method for constructing the dual polarized antenna feed system 20 can include arranging or positioning the first single polarized antenna feed element 22 on the first axis relative to the polarization filter 26 and so that the polarization of the first single polarized antenna feed element 22 is parallel to the plurality of conductors 32 and arranging or positioning the second single polarized antenna feed element 24 on the second axis relative to the polarization filter 26 and so that the polarization of the second single polarized antenna feed element 24 is orthogonal to the plurality of conductors 32.

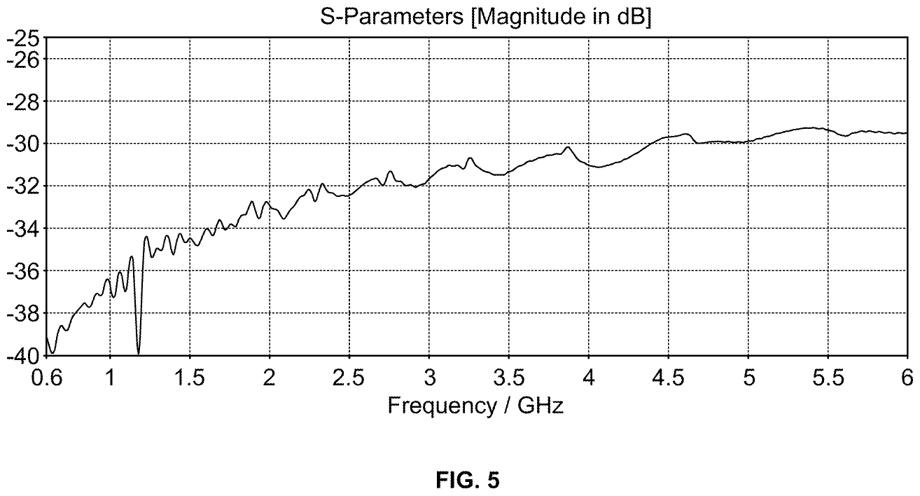

Constructing the dual polarized antenna feed system 20 in this manner so that the first and second single polarized antenna feed elements 22, 24 are separated can provide for a simplified mechanical structure when compared with known dual polarized antenna feed systems. Furthermore, as seen in the graph of exemplary isolation between the first single polarized antenna feed element 22 and the second single polarized antenna feed element 24 illustrated in FIG. 5, arranging and positioning the first single polarized antenna feed element 22 and the second single polarized antenna feed element 24 relative to the polarization filer 26 as described herein can achieve a substantial improvement in the isolation when compared with known dual polarized antenna feed systems.

Embodiments described herein can also include a method for operating the dual polarized antenna feed system 20. For example, in some embodiments, the method of operation can include receiving the incident signals originating from the first single polarized antenna feed element 22 at the polarization filter 26, receiving the incident signals originating from the second single polarized antenna feed element 24 at the polarization filter 26, reflecting the majority of the incident signals originating from the first single polarized antenna feed element 22 off of the polarization filter 26, and passing the majority of the incident signals originating from the second single polarized antenna feed element 24 through the polarization filter 26.

Although a few embodiments have been described in detail above, other modifications are possible. For example, other components may be added to or removed from the described systems, and other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A dual polarized antenna feed system comprising:
a first single polarized antenna feed element;
a second single polarized antenna feed element; and
a polarization filter positioned between the first single polarized antenna feed element and the second single polarized antenna feed element,
wherein the first single polarized antenna feed element is oriented on a first axis relative to the polarization filter,
wherein the second single polarized antenna feed element is oriented on a second axis relative to the polarization filter,
wherein the first axis and the second axis are not common and not parallel,
wherein the polarization filter includes a plurality of conductors,
wherein a polarization of the first single polarized antenna feed element is parallel to the plurality of conductors so that the polarization filter is configured to reflect a majority of incident signals originating from the first single polarized antenna feed element, and
wherein a polarization of the second single polarized antenna feed element is orthogonal to the plurality of conductors so that the polarization filter is configured to be transparent to a majority of incident signals originating from the second single polarized antenna feed element.

2. The dual polarized antenna feed system of claim 1 further comprising:
a parabolic reflector positioned relative to the first single polarized antenna feed element and the second signal polarized antenna feed element so as to be configured to be fed by the incident signals originating from the first single polarized antenna feed element and reflected by the polarization filter and the incident signals originating from the second single polarized antenna feed element and passing through the polarization filter.

3. The dual polarized antenna feed system of claim 1 wherein the first single polarized antenna feed element includes a first log periodic dipole array, and wherein the second single polarized antenna feed element includes a second log periodic dipole array.

4. The dual polarized antenna feed system of claim 1 wherein the first single polarized antenna feed element includes a first patch antenna, and wherein the second single polarized antenna feed element includes a second patch antenna.

5. The dual polarized antenna feed system of claim 1 wherein the first single polarized antenna feed element includes a first waveguide horn, and wherein the second single polarized antenna feed element includes a second waveguide horn.

6. The dual polarized antenna feed system of claim 1 wherein the plurality of conductors includes a plurality of parallel metal wires.

7. The antenna system of claim 1 wherein the plurality of conductors includes a plurality of parallel copper strips on a printed circuit board.

8. The antenna system of claim 1 wherein the first axis is 90° relative to the second axis, wherein the first axis is 45° relative to the polarization filter, and wherein the second axis is 45° relative to the polarization filter.

9. A method for constructing a dual polarized antenna feed system, the comprising:
arranging or positioning a first single polarized antenna feed element on a first axis relative to a polarization filter and so that a polarization of the first single polarized antenna feed element is parallel to a plurality of conductors of the polarization filter; and
arranging or positioning a second single polarized antenna feed element on a second axis relative to the polarization filter and so that a polarization of the second single polarized antenna feed element is perpendicular to the plurality of conductors,
wherein the first axis and the second axis are not common and not parallel.

10. The method of claim 9 further comprising:
positioning a parabolic reflector relative to the polarization filter so that the parabolic reflector is configured to be fed by incident signals originating from the first single polarized antenna feed element and reflected by the polarization filter and incident signals originating from the second polarized antenna feed element and passing through the polarization filter.

11. The method of claim 9 wherein the first single polarized antenna feed element includes a first log periodic dipole array, and wherein the second single polarized antenna feed element includes a second log periodic dipole array.

12. The method of claim 9 wherein the first single polarized antenna feed element includes a first patch antenna, and wherein the second single polarized antenna feed element includes a second patch antenna.

13. The method of claim 9 wherein the first single polarized antenna feed element includes a first waveguide horn, and wherein the second single polarized antenna feed element includes a second waveguide horn.

14. The method of claim 9 wherein the plurality of conductors includes a plurality of parallel metal wires.

15. The method of claim 9 wherein the plurality of conductors includes a plurality of parallel copper strips on a printed circuit board.

16. The method of claim 9 wherein the first axis is 90° relative to the second axis, wherein the first axis is 45° relative to the polarization filter, and wherein the second axis is 45° relative to the polarization filter.

17. A method for operating a dual polarized antenna feed system, the method comprising:
receiving incident signals originating from a first single polarized antenna feed element at a polarization filter;
receiving incident signals originating from a second single polarized antenna feed system at the polarization filter;
reflecting a majority of the incident signals originating from the first single polarized antenna feed element off of the polarization filter; and
passing a majority of the incident signals originating from the second single polarized antenna feed element through the polarization filter.

18. The method of claim 17 wherein the polarization filter includes a plurality of conductors.

19. The method of claim 18 wherein the plurality of conductors includes a plurality of parallel metal wires.

20. The method of claim 18 wherein the plurality of conductors includes a plurality of parallel copper strips on a printed circuit board.
